(19) United States
(12) Patent Application Publication
(10) Pub. No.: US 2021/0362120 A1
(43) Pub. Date: Nov. 25, 2021

(54) ELECTRIC CHEMICAL REACTOR AND SYSTEM

(71) Applicant: Preservation Tech LLC, Hull, IA (US)

(72) Inventor: Phillip Gerard Langhorst, St. Louis, MO (US)

(21) Appl. No.: 17/329,845

(22) Filed: May 25, 2021

Related U.S. Application Data
(60) Provisional application No. 63/029,583, filed on May 25, 2020.

(51) Int. Cl. B01J 19/00

(52) U.S. Cl. CPC B01J 19/0013; B01J 2219/00132; B01J 19/0053

(57) ABSTRACT

An electric chemical discharge reactor and associated systems include various physical arrangements of components that improve mounting configurations and densities, increase separation between electrical and coolant components, and/or shorten high frequency leads. In some cases a discharge reactor includes a power converter, a transformer, and a discharge reaction cell. An arrangement of the electrical components with respect to the reaction cell reduces the likelihood of liquid coolants reaching the electrical components. Components can be mounted to a common frame allowing for easy mounting and removal of the components at the same time. Fluid connection lines can include identically angled ends to further facilitate mounting and removal of the reactor.

### CROSS-REFERENCE TO RELATED APPLICATION(S)

This application claims the benefit under 35 U.S.C. § 119(e) to U.S. Provisional application 63/029,583, filed May 25, 2020 and entitled “Electric Chemical Reactor System,” which is hereby incorporated herein by reference in its entirety.

### TECHNICAL FIELD

The disclosed technology relates generally to chemical reactors configured to produce chemical substances through electric discharge.

### BACKGROUND

Electric chemical reactions are often used to manufacture particular chemical substances, including by high voltage discharge. One example is the production of a desired molecular substance by plasma reaction of an input gas. The plasma is effective in breaking chemical bonds, thereby facilitating the creation of other chemical bonds. Plasma is used in the production of many desirable chemicals such as producing ammonia from nitrogen and hydrogen, converting carbon dioxide into useful hydrocarbons, and generating ozone from oxygen.

An example of an electric discharge reactor has a reaction cell that receives an input chemical fluid such as a gas or liquid. In some cases the reaction cell may also be pressurized depending upon the particular reaction. The reaction cell typically includes two electrodes of opposing polarity, which in some cases are configured as electrode plates. In some cases a dielectric material is also positioned between the electrodes. For example, in some cases the dielectric material may be deposited on the surface of one of the electrodes. During operation, the input fluid is directed through a passage between the two electrodes and a high voltage is applied. When the applied voltage reaches a sufficient threshold, the electric field between the electrodes breaks down, causing electricity to discharge through the input fluid. The resulting electric current has the ability to break some of the chemical bonds of the input fluid, thereby forming different types of desired molecules.

While electric discharge reactors are useful for manufacturing various gases and other chemical products, the reactors can also have undesirable aspects. As an example, the fluid passage(s) extending through a reaction cell are generally very narrow and are thus prone to becoming contaminated with water or debris carried by the input fluid. The contamination leads to the need to frequently remove and service or replace particular reaction cells. In addition, to achieve the desired electric discharge, a reaction cell is connected to a high-power source such as a transformer driven by a high frequency electronic power converter. The high frequency operation of the transformer can be a source of unwanted electrical noise. Another undesirable aspect of electric discharge reactors is that the electric discharge process is often inefficient, leading to the wasteful generation of much heat. In some cases a reaction cell is cooled with air, water, or another coolant to enable continuing operation of the cell.

Multiple reaction cells are often used to generate a sufficient amount of a reactor product. Installing several reactors at a site while also addressing high frequency noise, removability, and connections to power, input, output, and coolant lines can be difficult. In some cases the complexity of the installation is increased because the reaction cells and associated transformers and power converters are separately mounted in a single cabinet.

There is thus a need in the art for improved electric chemical discharge reactors and associated systems and methods.

### SUMMARY

One general aspect of the disclosed technology includes an electric discharge reactor. The electric discharge reactor includes a frame supporting a power converter, a transformer and an electric discharge reaction cell. The frame is configured to mount to a vertical surface and includes a component plate extending in a vertical orientation when the frame is mounted to the vertical surface. The power converter and transformer are mounted to the component plate. The electric discharge reaction cell is mounted to the component plate below the power converter. The reaction cell includes at least one power connector configured to be electrically coupled with the power converter and the transformer, an input fluid connector configured to connect the reaction cell to a source of supply fluid for reacting in the reaction cell, an output fluid connector configured to provide a fluid produced by the reaction cell, and a liquid cooling system that includes first and second coolant connectors. According to various implementations, the mounted position of the reaction cell locates the first and second coolant connectors below the power converter, thereby enabling gravity to direct coolant escaping from the liquid cooling system, the first coolant connector, or the second coolant connector away from the power converter.

Implementations according to this aspect may include one or more of the following features. In some cases the power converter is mounted proximate a top end of the frame and the reaction cell is mounted proximate a bottom end of the frame. The reaction cell may include a top half and a bottom half, where the first and second coolant connectors extend from the bottom half of the reaction cell. The at least one power connector extends from the top half of the reaction cell away from the first and second coolant connectors. In some cases at least one of the first and second coolant connectors is located proximate a bottom end of the frame and extends down away from the power converter and the top end of the frame. The transformer may be mounted to the component plate between the power converter and the reaction cell. The reactor further may include a narrow configuration in which the depth of the reactor is greater than the width of the reactor and the height of the reactor is greater than the depth of the reactor. The frame further may include a vertical mounting plate configured to mount to the vertical surface. In such cases the component plate and the vertical mounting plate extend in the vertical orientation along a height of the reactor. In some cases the vertical mounting plate extends in a first horizontal orientation transverse to the vertical orientation along a width of the reactor and in some cases the component plate extends in a second horizontal orientation transverse to the vertical orientation and the first horizontal orientation along a depth of the reactor.

Another general aspect of the disclosed technology includes an electric discharge reaction system. The electric discharge reaction system includes an electric discharge reactor and multiple connection lines. The electric discharge reactor includes a frame with a vertical mounting plate and a component plate. It also includes a power converter mounted to the component plate, a transformer mounted to the component plate below the power converter, and an electric discharge reaction cell mounted to the component plate below the transformer. The reaction cell includes at least one power connector configured to be electrically coupled with the power converter and the transformer, an input fluid connector, an output fluid connector, and a liquid cooling system with first and second coolant connectors. The multiple connection lines of the electric discharge reaction system are coupled to the input fluid connector, the output fluid connector and the first and second coolant connectors. The connection lines extend down below and away from the electric discharge reactor. According to various implementations, the positioning of the first and second coolant connectors and the plurality of connection lines below the power converter enables gravity to direct coolant escaping from the liquid cooling system, the first coolant connector, the second coolant connector, or one or more of the connection lines away from the power converter.

Implementations of this general aspect may include one or more of the following features. In some cases each of the connection lines includes a first end configured to couple to one of the first and second coolant connectors, the input fluid connector and the output fluid connector, and a second end configured to couple to a fluid delivery conduit. In some cases the first and second ends of at least one of the connection lines are formed at a same connection angle. In some cases the first and second ends of each of the connection lines are formed at a same connection angle. The connection angle for each of the connection lines may be different than the connection angles for the other connection lines. The connection lines may include stainless-steel tubing. In some cases the power converter is mounted proximate a top end of the frame and the reaction cell is mounted proximate a bottom end of the frame. The reaction cell may include a top half and a bottom half, where the first and second coolant connectors extend from the bottom half of the reaction cell and where the at least one power connector extends from the top half of the reaction cell away from the first and second coolant connectors. According to various implementations, the component plate and the vertical mounting plate extend along a height of the electric discharge reactor, the component plate further extends along a depth of the electric discharge reactor that is less than the height, and the vertical mounting plate further extends along a width of the electric discharge reactor that is less than the depth. In some cases the electric discharge reaction system includes multiple fluid delivery conduits including, for example, a first coolant conduit, a second coolant conduit, a supply fluid conduit, and a product delivery conduit.

Another general aspect of the disclosed technology includes an electric discharge reaction system. The electric discharge reaction system includes multiple electric discharge reactors and multiple fluid delivery manifolds. In some cases the fluid delivery manifolds include a first coolant manifold, a second coolant manifold, a supply fluid manifold, and a product delivery manifold. The system also includes multiple rigid connection lines. Each of the electric discharge reactors includes a frame with a vertical mounting plate and a component plate, each plate extending in a vertical orientation when the frame is mounted to the vertical surface. Each reactor also includes a power converter and a transformer mounted to the component plate and an electric discharge reaction cell mounted to the component plate below the power converter. The reaction cell includes at least one power connector configured to be electrically coupled with the power converter and the transformer, an input fluid connector coupled to the supply fluid manifold with a first one of the connection lines, an output fluid connector coupled to the product delivery manifold with a second one of the connection lines, and a liquid cooling system with first and second coolant connectors respectively coupled to the first and second coolant manifolds. According to various implementations, the mounted position of the reaction cell locates the first and second coolant connectors and corresponding connection lines below the power converter, thereby enabling gravity to direct coolant escaping from the liquid cooling system, the first coolant connector, the second coolant connector, or one of the connection lines away from the power converter.

Implementations according to this aspect may include one or more of the following features. In some cases each of the rigid connection lines has a first end and a second end. The first and second ends of at least one of the rigid connection lines are formed at a same connection angle. In some cases the first and second ends of each of the rigid connection lines are formed at a same connection angle that is different from the connection angles for the other connection lines.

While multiple embodiments are disclosed, still other embodiments will become apparent to those skilled in the art from the following detailed description, which shows and describes illustrative embodiments. As will be realized, the various implementations are capable of modifications in various obvious aspects, all without departing from the spirit and scope thereof. Accordingly, the drawings and detailed description are to be regarded as illustrative in nature and not restrictive.

### BRIEF DESCRIPTION OF THE DRAWINGS

FIG. 1 is a perspective view of an electric discharge reactor according to an embodiment.

FIG. 2 is an exploded view of the reactor of FIG. 1.

FIG. 3 is a partial, perspective view of an electric discharge reactor system according to an embodiment.

FIG. 4 is a side view of the reactor system of FIG. 3.

FIG. 5 is a partial, perspective view of another electric discharge reactor system according to an embodiment.

### DETAILED DESCRIPTION

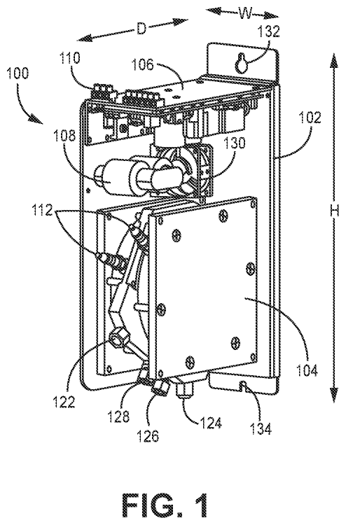

Turning to the drawings, FIG. 1 is a perspective view of an electric discharge reactor 100 according to one possible embodiment. The reactor 100 generally includes a frame 102 that supports a reaction cell 104 and power circuitry that includes a power converter 106 and a transformer 108. According to various implementations, the electric discharge reactor 100 is a corona discharge reactor that generates high voltage corona discharges to convert a chemical input fluid into a desirable output fluid. For example, in some cases the reactor 100 is configured to receive air or oxygen as an input fluid and generate ozone through corona discharge. Implementations are not limited to ozone generation. In various cases the reactor 100 is configured to generate any of a variety of chemical substances through electric chemical reaction.

As will be understood by those skilled in the art, the power converter 106 and the transformer 108 are constructed to provide sufficient power for driving electric corona discharge reactions within the reaction cell 104. As an example, in some implementations the power converter 106 is constructed or configured to condition and regulate power received from a power supply before resupplying the power to the transformer 108. In some cases the power converter 106 is configured to drive the transformer 108 at a high frequency.

As shown in FIG. 1, the power converter 106 in this example takes the form of an electronic control board with connectors 110 for connecting to a power supply. In some implementations, for example, one or more power cables plugs into the power connectors 110 to connect the reactor 100 to, e.g., a central power supply. Such a power supply may power one, two, or multiple individual reactors. For implementations with pluggable power connectors, the pluggable nature of the connectors can facilitate the easy removal or replacement of the discharge reactor 100. Although not depicted, it is also understood that appropriate electrical connections are made between the power converter 106, the transformer 108 and the reaction cell 104 during operation. In some implementations the physical arrangement and mounting of the power converter 106, transformer 108, and reaction cell enable the use of shortened electrical leads, which can reduce the amount of high frequency noise generated by the leads during operation.

In the depicted implementation the reaction cell 104 includes two power connectors 112 for supplying the reaction cell with electricity from the transformer 108. While two power connectors 112 are depicted, the reaction cell 104 may have any suitable number of power connectors. In some cases a reaction cell may have one, two, three or more power connectors depending upon the particular cell design.

As shown in FIG. 1, the reaction cell 104 includes additional connectors for input and output fluids. In this example the additional connectors include an input fluid connector 126 for receiving a supply or feed fluid and an output fluid connector 128 for providing a fluid produced within the cell. The additional connectors in this example also include first and second coolant connectors 122, 124. The coolant connectors 122, 124 provide access to a liquid cooling system of the reaction cell, enabling the cooling system to be connected with a source of coolant such as, for example, water or another suitable substance. The liquid cooling system of the reaction cell 104 is example of an optional feature that may be provided in various implementations. In some implementations, a reaction cell may instead have an air-cooling system including, for example, an air-cooled heat sink. Some implementations may employ both liquid and air cooling.

In various implementations an electric discharge reactor may include other components and/or features in addition to the frame 102, reaction cell 104, power converter 106, and transformer 108 shown in FIG. 1. For example, in some cases the discharge reactor 100 of FIG. 1 includes a fan 130 for cooling the transformer 108 and/or other components. In some implementations a separate communications board or other electronics may also be mounted to the frame 102. In the example of FIG. 1, the reactor 100 also includes mounting features on the frame 102 such as a keyhole 132 and a slot 134 that enable the reactor to be easily mounted and dismounted from a wall or panel. Other mounting features in addition to or instead of the keyhole and slot are also possible including, for example, dove tails, grooves, tongues, clips, rails, and the like. In various implementations the discharge reactor 100 may include other features and components known in the art.

In cases involving a liquid cooling system, it will be appreciated that liquid coolant escaping from the cooling system poses a threat to sensitive electronic components of the discharge reactor. As examples, in some cases liquid coolant may leak from the cell's coolant connectors or from another part of the liquid cooling system, or escape when connecting or disconnecting coolant lines. According to various implementations, the physical arrangement of the reaction cell 104, power converter 106, and transformer 108 reduces the likelihood that escaping coolant will interfere with the reactor's electrical components. Returning to FIG. 1, in this implementation the power converter 106 is mounted at a top end of the frame 102, the reaction cell 104 is mounted at a bottom end of the frame 102, and the transformer 108 is mounted to the frame 102 below the power converter but above the reaction cell. This mounting arrangement provides a physical separation between the liquid cooling system of the reaction cell 104 and the electrical components of the reactor 100. The physical separation reduces the risk that coolant will short or otherwise impact the power converter 106 and transformer 108.

In some implementations the connectors for the cell cooling system may be further arranged to maximize the distance between one or more coolant connectors and the power converter 106 and transformer 108. As an example, in the depicted implementation the first coolant connector 122 is positioned on the bottom half of the reaction cell 104, further away from the power converter 106 than the top half of the reaction cell 104. In addition, the second coolant connector 124 is located at the bottom edge of the reaction cell 104. This placement maximizes the distance between the coolant connector 124 and the power converter 106 and transformer 108. In this implementation the placement of both coolant connectors 122, 124 also physically separates the coolant connectors from the cell's power connectors 112, which extend from the top half of the reaction cell 104.

According to some implementations, the relative placement of the reaction cell 104 with respect to the power converter 106 and the transformer 108 also reduces the likelihood that the electrical components will be affected by coolant from the reaction cell's liquid cooling system. Mounting the discharge reactor 100 as shown in FIG. 1 orients the reactor and its components so that the reaction cell 104 is positioned below the power converter 106 and the transformer 108. Gravity's effect means that liquid coolant escaping from the cell's cooling system (and/or the coolant supply lines) will fall down and away from the reactor without hitting the electrical components. Further, in the depicted implementation the relative position of the reaction cell and the coolant connectors' placement on the reaction cell 104 means that the bulk of the reaction cell is located between the coolant connectors and the electrical components. The body of the reaction cell can thus to some extent shield the power converter 106 and the transformer 108 in the case that pressurized coolant squirts or sprays from leaks in the coolant connectors 122, 124.

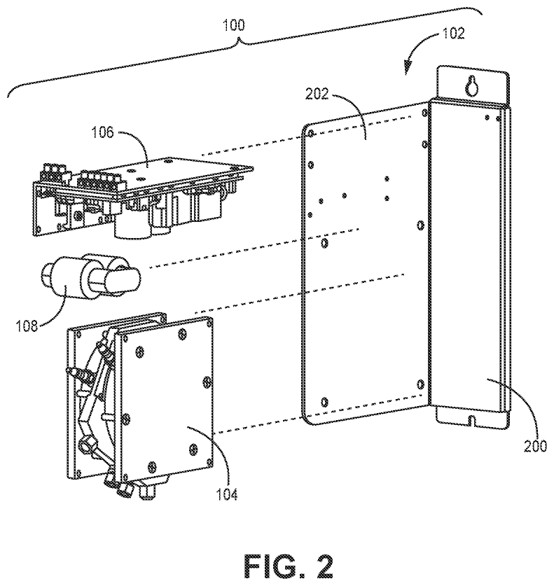

FIG. 2 provides an exploded view of the reactor 100 according to various implementations. The frame 102 in this example includes a panel or wall mounting plate 200 formed at a right angle with a component plate 202. The wall mounting plate 200 is configured to mount to a vertical surface and is also referred to herein as a vertical mounting plate. With the frame mounted to a vertical surface, both the vertical mounting plate and the component plate extend in a vertical orientation along a height of the reactor. In addition, the vertical mounting plate extends in a first horizontal orientation transverse to the vertical orientation along a width of the reactor. Further, the component plate in this case extends in a second horizontal orientation transverse to the vertical orientation and the first horizontal orientation, along a depth of the reactor.

According to some implementations the reaction cell 104, the power converter 106, and the transformer 108 may be bolted or clipped onto the component plate 202 of the frame. Other fastening mechanisms may also be used. Other shapes and configurations for the frame 102 may also be employed in various implementations. As shown in FIGS. 1-2, in this example the frame 102 and the discharge reactor 100 as a whole has a narrow width W relative to its height H and depth D. As will be discussed further herein, the relative narrowness of the discharge reactor 100 can in some cases facilitate the mounting of several reactors side-by-side.

According to various implementations, an electric discharge reactor system includes an electric discharge reactor and multiple connection lines for coupling the reactor to a feed or supply fluid source, a coolant source, and a product delivery system for delivering a fluid manufactured by the reactor. In some cases a reactor system also includes multiple fluid delivery conduits that couple the reactor connection lines to the fluid source, coolant source, and product delivery system.

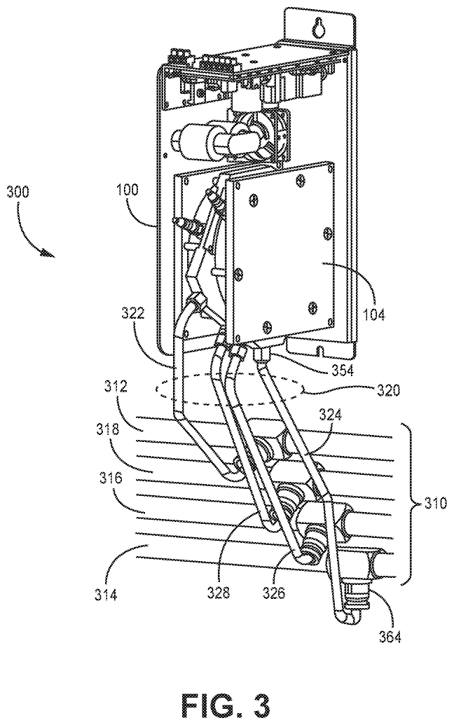

Turning to FIG. 3, a partial, perspective view is provided of one example of an electric discharge reactor system 300 according to various implementations. As shown, the reactor system 300 includes an electric discharge reactor 100, which in this case is the reactor discussed with respect to FIGS. 1-2. Other reactors may also be used. The reactor system 300 also includes multiple fluid delivery conduits 310 and connection lines 320 coupling the reactor 100 to the fluid conduits. In some cases the reactor system may only include the reactor 100 and the connection lines 320. As will be appreciated, the fluid delivery conduits 310 may be plastic or metal pipes or hoses, or have another suitable configuration. In various implementations the connection lines 320 between the reactor 100 and the fluid conduits are made from metal or plastic tubing. In various implementations one or more of the fluids transported by the delivery conduits and connection lines are corrosive, thus requiring the use of pipes and tubing made from stainless-steel or another suitable material.

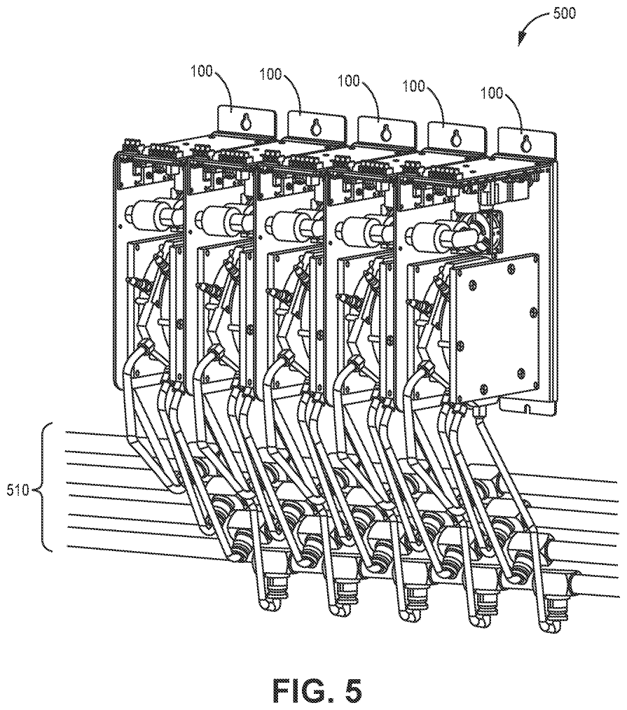

Continuing with reference to FIG. 3, the delivery conduits 310 of the reactor system 300 includes coolant conduits 312 and 314, a supply fluid conduit 316, and a product delivery conduit 318. In some implementations these fluid delivery conduits may provide a direct and/or dedicated connection between the reactor 100 and various end points such as, for example, fluid storage tanks and cooling and dispersal equipment. In some implementations the fluid delivery conduits may connect multiple reactors together within a larger system. In such cases the fluid delivery conduits may also be referred to herein as fluid delivery manifolds. An example of such a system will be described further herein with respect to FIG. 5.

Corresponding connection lines 322, 324, 326, and 328 couple the conduits to the discharge reactor 100. In this example the connection lines 322, 324, 326, and 328 are made of stainless-steel tubing, which is known to be very stiff or rigid. According to various implementations, one or more of the connection lines are configured to facilitate connecting and disconnecting the stiff connection lines 320 (e.g., from stainless-steel or another material) from the reactor cell 104 and the delivery conduits 310. As an example, in implementations using stiff tubing, the connection angles of both ends of one or more connection lines 320 are the same. The use of identical angles (referred to herein as both connection angles and entry angles) in this way allows for loosening the connectors at each end of the connection line(s) and then easily sliding the connection line(s) out from the corresponding connectors while the discharge reactor 100 and its frame stay firmly attached to a wall or panel. For example, with respect to the implementation in FIG. 3, the connectors 354, 364 can be loosened sufficiently and then the connection line 324 can be disengaged from both the reaction cell 104 and the coolant conduit 314 at the same time by moving the connection line 324 steadily downward. Reconnection of the connection line 324 can be accomplished by the reverse steps.

In some implementations all of the connection lines 320 have ends with identical angles, though the angles may change from line to line. In some cases less than all of the connection lines 320 may have ends with identical angles.

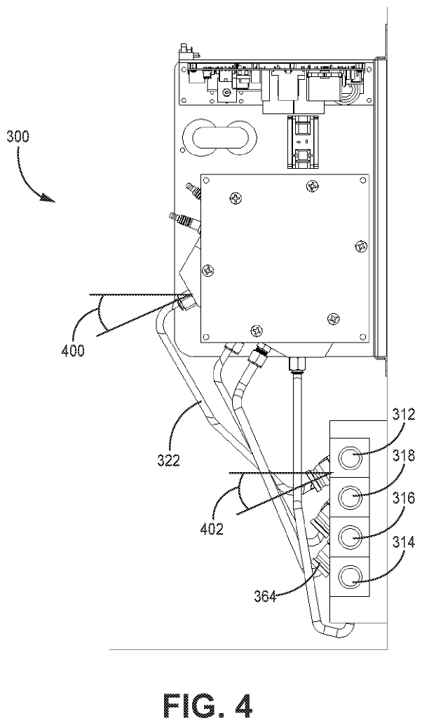

Turning to FIG. 4, a side view of the reactor system 300 in FIG. 3 is shown. From this side view the identical entry or connection angles of the connection lines can be seen. The entry angles 400 and 402 of connection line 322 are shown as one example. Further, it can be seen that the other connection lines also have identical connection angles at each end, though the entry angle may vary from line to line.

FIG. 5 is a partial, perspective view of another electric discharge reactor system 500 according to an embodiment. As shown, the reactor system 500 includes multiple instances of the same discharge reactor 502 arranged for mounting to a wall or panel (not shown). Each reactor 502 includes multiple connection lines as in previous examples which couple the reaction cells to fluid delivery manifolds 510. The implementation in FIG. 5 particularly illustrates how the narrow dimensions of the reactors 502 in combination with the connection lines with identical angles enables a mounting density greater than what might otherwise be possible. In addition, the mounting arrangement for the power converters and transformers with respect to the reaction cells, as well as the connection lines and delivery manifolds, illustrates how the orientations and configurations of the reactors 502 physically separate the electrical components from liquid coolant, thus reducing the likelihood that coolant may hinder or damage the operation of the electrical components.

Although the various embodiments have been described with reference to preferred implementations, persons skilled in the art will recognize that changes may be made in form and detail without departing from the spirit and scope thereof.

What is claimed is:

1. An electric discharge reactor, comprising:
a frame configured to mount to a vertical surface, the frame comprising a component plate extending in a vertical orientation when the frame is mounted to the vertical surface;
a power converter mounted to the component plate;
a transformer mounted to the component plate; and
an electric discharge reaction cell mounted to the component plate below the power converter, the reaction cell comprising:
at least one power connector configured to be electrically coupled with the power converter and the transformer;
an input fluid connector configured to connect the reaction cell to a source of supply fluid for reacting in the reaction cell;
an output fluid connector configured to provide a fluid produced by the reaction cell; and
a liquid cooling system comprising first and second coolant connectors;
wherein the mounted position of the reaction cell locates the first and second coolant connectors below the power converter.

2. The electric discharge reactor of claim 1, wherein the power converter is mounted proximate a top end of the frame and the reaction cell is mounted proximate a bottom end of the frame.

3. The electric discharge reactor of claim 1, wherein the reaction cell comprises a top half and a bottom half, wherein the first and second coolant connectors extend from the bottom half of the reaction cell.

4. The electric discharge reactor of claim 3, wherein the at least one power connector extends from the top half of the reaction cell away from the first and second coolant connectors.

5. The electric discharge reactor of claim 3, wherein at least one of the first and second coolant connectors is located proximate a bottom end of the frame and extends down away from the power converter and the top end of the frame.

6. The electric discharge reactor of claim 1, wherein the transformer is mounted to the component plate between the power converter and the reaction cell.

7. The electric discharge reactor of claim 1, wherein the frame further comprises a vertical mounting plate configured to mount to the vertical surface, and wherein:
the component plate and the vertical mounting plate extend in the vertical orientation along a height of the reactor;
the vertical mounting plate extends in a first horizontal orientation transverse to the vertical orientation along a width of the reactor; and
the component plate extends in a second horizontal orientation transverse to the vertical orientation and the first horizontal orientation along a depth of the reactor.

8. The electric discharge reactor of claim 6, wherein the reactor further comprises a narrow configuration in which the depth of the reactor is greater than the width of the reactor and the height of the reactor is greater than the depth of the reactor.

9. An electric discharge reaction system, comprising:
an electric discharge reactor comprising:
a frame comprising a vertical mounting plate and a component plate;
a power converter mounted to the component plate;
a transformer mounted to the component plate below the power converter; and
an electric discharge reaction cell mounted to the component plate below the transformer, the reaction cell comprising:
at least one power connector configured to be electrically coupled with the power converter and the transformer;
an input fluid connector;
an output fluid connector; and
a liquid cooling system comprising first and second coolant connectors; and
a plurality of connection lines coupled to the input fluid connector, the output fluid connector and the first and second coolant connectors;
wherein the plurality of connection lines extend down below and away from the electric discharge reactor; and
wherein the positioning of the first and second coolant connectors and the plurality of connection lines below the power converter enables gravity to direct coolant escaping from the liquid cooling system, the first coolant connector, the second coolant connector, or one or more of the connection lines away from the power converter.

10. The electric discharge reaction system of claim 9, wherein each of the plurality of connection lines comprises:
a first end configured to couple to one of the first and second coolant connectors, the input fluid connector and the output fluid connector, and
a second end configured to couple to a fluid delivery conduit; and
wherein the first and second ends of at least one of the plurality of connection lines are formed at a same connection angle.

11. The electric discharge reaction system of claim 10, wherein the first and second ends of each of the plurality of connection lines are formed at a same connection angle.

12. The electric discharge reaction system of claim 11, wherein the connection angle for each of the connection lines is different than the connection angles for the other connection lines.

13. The electric discharge reaction system of claim 9, wherein the connection lines comprise stainless-steel tubing.

14. The electric discharge reaction system of claim 9, wherein the power converter is mounted proximate a top end of the frame and the reaction cell is mounted proximate a bottom end of the frame.

15. The electric discharge reaction system of claim 9, wherein the reaction cell comprises a top half and a bottom half, wherein the first and second coolant connectors extend from the bottom half of the reaction cell and wherein the at least one power connector extends from the top half of the reaction cell away from the first and second coolant connectors.

16. The electric discharge reaction system of claim 9, wherein:
the component plate and the vertical mounting plate extend along a height of the electric discharge reactor;
the component plate further extends along a depth of the electric discharge reactor that is less than the height; and
the vertical mounting plate further extends along a width of the electric discharge reactor that is less than the depth.

17. The electric discharge reaction system of claim 9, further comprising a plurality of fluid delivery conduits comprising:
a first coolant conduit;
a second coolant conduit;
a supply fluid conduit; and
a product delivery conduit.

18. An electric discharge reaction system, comprising:
a plurality of electric discharge reactors;
a plurality of fluid delivery manifolds comprising:
a first coolant manifold;
a second coolant manifold;
a supply fluid manifold; and
a product delivery manifold; and
a plurality of rigid connection lines;
wherein each of the electric discharge reactors comprises:
a frame comprising a vertical mounting plate and a component plate, each plate extending in a vertical orientation when the frame is mounted to the vertical surface;
a power converter mounted to the component plate;
a transformer mounted to the component plate; and
an electric discharge reaction cell mounted to the component plate below the power converter, the reaction cell comprising:
at least one power connector configured to be electrically coupled with the power converter and the transformer;
an input fluid connector coupled to the supply fluid manifold with a first one of the plurality of connection lines;
an output fluid connector coupled to the product delivery manifold with a second one of the plurality of connection lines; and
a liquid cooling system comprising first and second coolant connectors respectively coupled to the first and second coolant manifolds;
wherein the mounted position of the reaction cell locates the first and second coolant connectors and corresponding connection lines below the power converter, thereby enabling gravity to direct coolant escaping from the liquid cooling system, the first coolant connector, the second coolant connector, or one of the connection lines away from the power converter.

19. The electric discharge reaction system of claim 18, wherein each of the plurality of rigid connection lines comprises a first end and a second end, wherein the first and second ends of at least one of the plurality of rigid connection lines are formed at a same connection angle.

20. The electric discharge reaction system of claim 19, wherein the first and second ends of each of the plurality of rigid connection lines are formed at a same connection angle that is different from the connection angles for the other connection lines.
